(19) United States
(12) Patent Application Publication
(10) Pub. No.: US 2012/0105024 A1
(43) Pub. Date: May 3, 2012

(54) Feedback Regulating Circuit

(75) Inventors: Song-Yi Lin, Hsinchu County (TW); Hsuan-I Pan, Hsinchu County (TW); Hung I Wang, Hsinchu County (TW)

(73) Assignee: MStar Semiconductor, Inc., Hsinchu Hsien (TW)

(21) Appl. No.: 13/176,202

(22) Filed: Jul. 5, 2011

(30) Foreign Application Priority Data
Oct. 27, 2010 (TW) 099136632

(51) Int. Cl. G05F 1/10

(52) U.S. Cl. 323/234

(57) ABSTRACT

A feedback regulating circuit provides a regulated voltage to a multi-output circuit that outputs a plurality of output voltages. The feedback regulating circuit includes a voltage control unit, coupled to the plurality of output voltages, for generating a first voltage according to the plurality of output voltages and outputting a voltage control signal according to the first voltage; and a reference voltage generator, coupled to the voltage control unit, for receiving the voltage control signal and generating a reference voltage according to the voltage control signal, with the reference voltage being fed back to the multi-output circuit to regulate voltage to a high degree of accuracy.

### CROSS REFERENCE TO RELATED PATENT APPLICATION

This patent application is based on Taiwan, R.O.C. patent application No. 099136632 filed on Oct. 27, 2010.

### FIELD OF THE INVENTION

The present invention relates to a monitor circuit, and more particularly, to efficiency optimization of a light emitting diode (LED) driving system and a fault detection circuit.

### BACKGROUND OF THE INVENTION

Since an LED has numerous advantages, e.g., small volume, short response time, low power consumption, high reliability, and high mass-production feasibility, the LED is widely applied to electronic apparatuses as a light source. For example, the LED serves as a backlight source of a liquid crystal display (LCD) to replace a conventional fluorescent tube.

FIG. 1 is a schematic diagram of a conventional LED driving system comprising a plurality of LED strings 10, a boost controller 14, and a boost power stage circuit 16.

For the conventional LED driving system illustrated in FIG. 1, even if each LED string 10 implements a same voltage source V_{DC} and the same number of LEDs 100, since the LEDs 100 do not match with each other, voltages at input pads 11 are different. In order to reduce power consumption of the LED strings 10, a predetermined voltage is fed back to the boost controller 14 in the circuit design, e.g., a 1V voltage serves as a basis of control of the voltage source V_{DC} that is controlled via a feedback circuit design between the boost controller 14 and the boost power stage circuit 16, so that voltages at the input pads 11 are regulated to the predetermined voltage of 1V.

However, a demanded precision in accuracy cannot be achieved via the foregoing design, and thus efficiency optimization of the LED driving system cannot be achieved. In addition, the conventional LED driving system is lacking of a mechanism for monitoring a fault of the LED strings 10, e.g., a short-circuit fault or an open-circuit fault. Accordingly, when a serious fault of the LEDs 100 occurs, efficiency optimization of the LEDs 100 cannot be achieved via the boost controller 14 and the boost power stage circuit 16 of the conventional LED driving system.

Therefore, a novel mechanism of efficiency optimization and fault detection needed to effectively monitor an LED driving system as well as increasing an emitting efficiency.

### SUMMARY OF THE INVENTION

In view of the foregoing issues, according to an embodiment of the present invention, a feedback regulating circuit applied to an LED driving system monitors fault abnormality on top of reducing power consumption of the LED driving system.

According to an embodiment of the present invention, a feedback regulating circuit provides a regulated voltage to a multi-output circuit that outputs a plurality of output voltages. The feedback regulating circuit comprises a voltage control unit and a reference voltage generator. The voltage control unit coupled to the plurality of output voltages generates a first voltage according to the plurality of output voltages and outputs a voltage control signal according to the first voltage. The reference voltage generator coupled to the voltage control unit receives the voltage control signal and generates a reference voltage according to the voltage control signal, and the reference voltage is fed back to the multi-output circuit to regulate voltage to a given accuracy.

### BRIEF DESCRIPTION OF THE DRAWINGS

FIG. 1 is a schematic diagram of a conventional LED driving system.

FIG. 2 is a schematic diagram of a feedback regulating circuit in accordance with an embodiment of the present invention.

FIG. 3 is a schematic diagram of detailed circuits of an analog-to-digital converter (ADC) in accordance with an embodiment of the present invention.

FIG. 4 is a schematic diagram of detailed circuits of a low-pass filter (LPF) in accordance with an embodiment of the present invention.

FIG. 5 is a schematic diagram of detailed circuits of a boost controller and a boost power stage circuit in accordance with an embodiment of the present invention.

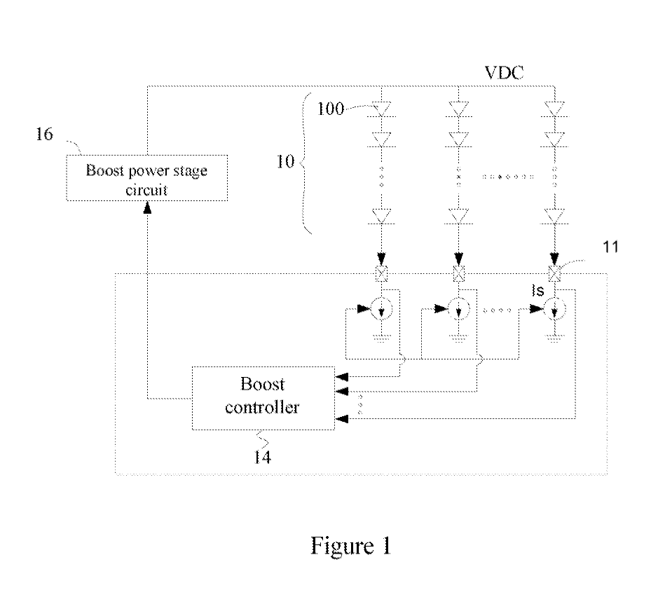

### DETAILED DESCRIPTION OF THE PREFERRED EMBODIMENT

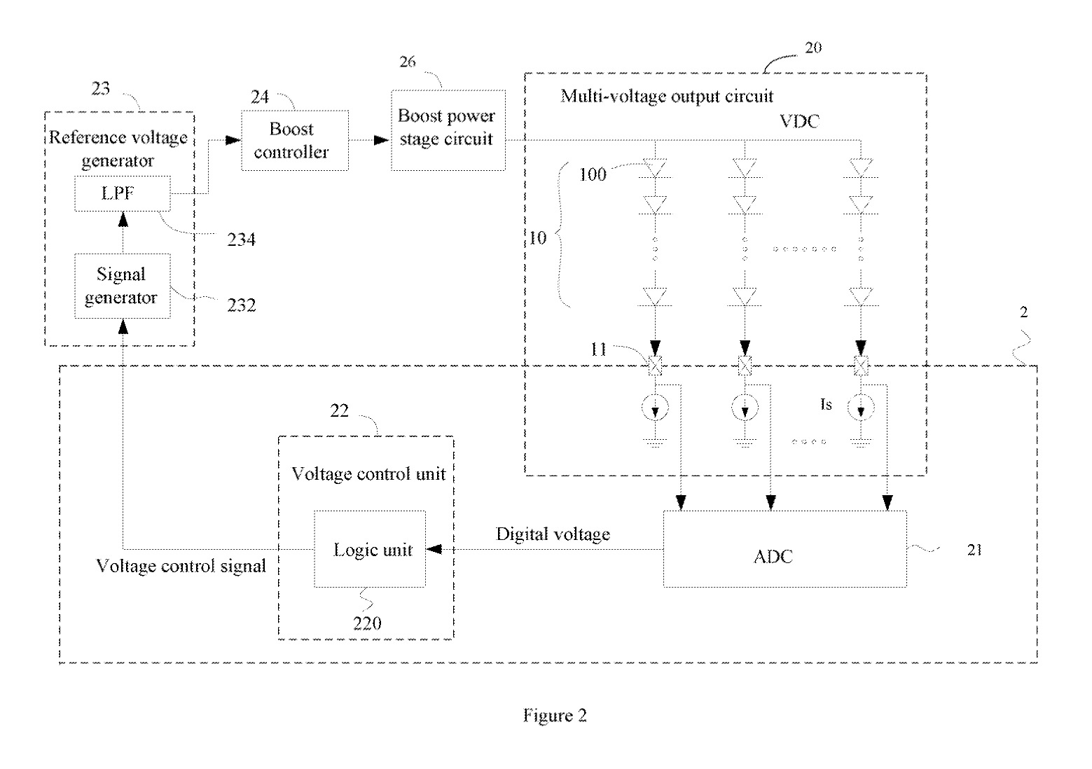

FIG. 2 shows a schematic diagram of a feedback regulating circuit in accordance with an embodiment of the present invention. The feedback regulating circuit provides a regulated voltage to a multi-output circuit 20 that outputs a plurality of output voltages. In this embodiment, the multi-output circuit 20 comprises a plurality of LED strings 10 whose luminances are controlled by a plurality of current sources I_{S}. Each LED string 10 comprises a plurality of LEDs 100 connected in serial. An outermost LED 100 of each LED string 10 has an anode coupled to a voltage source V_{DC}, and each LED string 100 has an inner-most LED 100 having a cathode coupled to an input pad of an integrated circuit (IC) 2. The multi-output circuit 20 is applicable to an LED driving system, e.g., a backlight module of a LCD.

In this embodiment, the feedback regulating circuit comprises a voltage control unit 22 and a reference voltage generator 23. The voltage control unit 22 is coupled to the output voltages so that the voltage control unit 22 generates a first voltage according to the output voltages and outputs a voltage control signal according to the first voltage, controlled by logic unit 220. In addition, the reference voltage generator 23, which is coupled to the voltage control unit 22, receives the voltage control signal and generates a reference voltage accordingly. The reference voltage feeds back to the multi-output circuit 20. Typically, the foregoing voltage control unit 22 is integrated in the IC 2, and the reference voltage generator 23 is typically disposed outside the IC 2. However, it is dependent on different design choices whether to integrate various modules and components into an IC circuit, and should not be limiting to the invention.

In addition, the feedback regulating circuit in this embodiment comprises an analog to digital converter ADC 21, coupled to the multi-output circuit 20, to convert the plurality of analog output voltages to a plurality of digital voltages that are fed back to the voltage control unit 22. The voltage control unit 22 selects one of the digital voltages as the first voltage. FIG. 3 shows a schematic diagram of details of the ADC 21 in accordance with an embodiment of the present invention. In this embodiment, the ADC 21 comprises a multiplexer 210 and an ADC unit 212. The multiplexer 210 receives the output voltages of the plurality of input pads 11, and selects one of the output voltages at a time to feed back to the ADC unit 212. The ADC unit 212 converts the output voltage selected by the multiplexer 210 to a digital voltage.

In this embodiment, the voltage control unit 22 comprises a logic unit 220, which selects one of the digital voltages according to a predetermined rule as the first voltage, and outputs a corresponding voltage control signal. In different embodiments, the predetermined rule is different according to different requirements. For example, in this embodiment, in order to increase an efficiency of the multi-output circuit 20, it is designed that a minimum output voltage is selected to minimize power consumption of the multi-output circuit 20. Therefore, the logic unit 220 selects the minimum voltage among the digital voltages as the first voltage. The logic unit 220 can be realized as hardware, as well as software, or any combinations thereof.

The reference voltage generator 23 is connected to the logic unit 220, and receives voltage control signals from the voltage control unit (22). The reference voltage generator 23 comprises a signal generator for generating a waveform according to the voltage control signal generated according to the first voltage. In this embodiment, the signal generator is a pulse width modulation (PWM) signal generator for generating different pulse widths that reflect the voltage control signal. In one embodiment, the logic unit 220 compares the first voltage with a target voltage to generate a difference to generate the voltage control signal accordingly, so that the signal generator 232 can adjust the output pulse width. More specifically, the signal generator 232 adjusts the pulse width in proportion to a ratio of the determined difference and the target voltage. When the feedback system is regulated, the target voltage is adjusted to approximate the first voltage. In an embodiment, the voltage control unit 22 adjusts the first voltage, and the reference voltage generator 23 generates a reference voltage, so that the target voltage is adjusted with the change of the first voltage. Accordingly, the voltage source connected to the multi-output circuit is adjusted to achieve a predetermined value or an ideal value of the system.

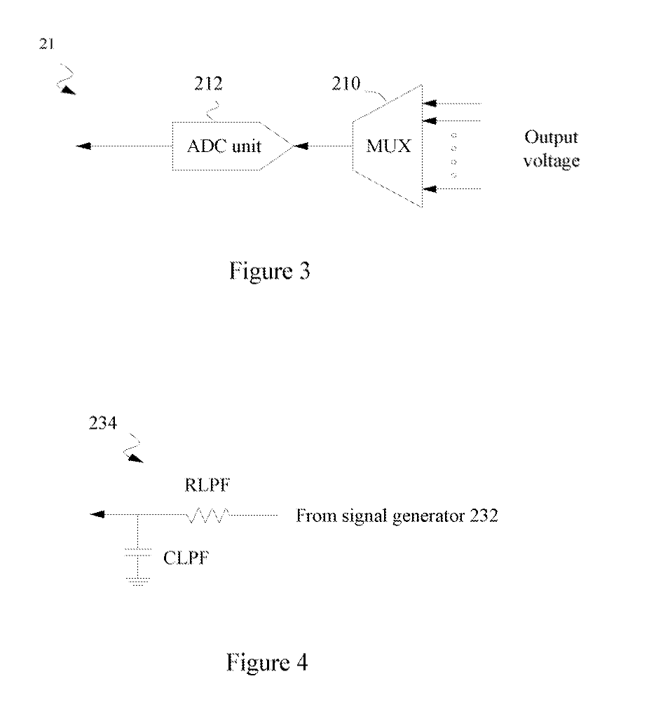

The reference voltage generator 23 further comprises a low-pass filter (LPF) 234 for retrieving direct-current (DC) components of the modulated waveform outputted from the signal generator 232 as the reference voltage. FIG. 4 shows a schematic diagram of details of the LPF 234 in accordance with an embodiment of the present invention. The LPF 234 comprises a resistor R_{LPF} and a capacitor C_{LPF}. The resistor R_{LPF} is connected to an output end of the signal generator 232, and the capacitor C_{LPF} is connected between the resistor R_{LPF} and ground.

The reference voltage from the reference voltage generator 23 is under the control of the voltage control signal. By adjusting its duty cycle, the output voltage is adjusted accordingly, so that the output voltage source of the multi-output circuit is modified; as a result, the minimum voltage of the output voltages can be accurately regulated and maintained at the target voltage.

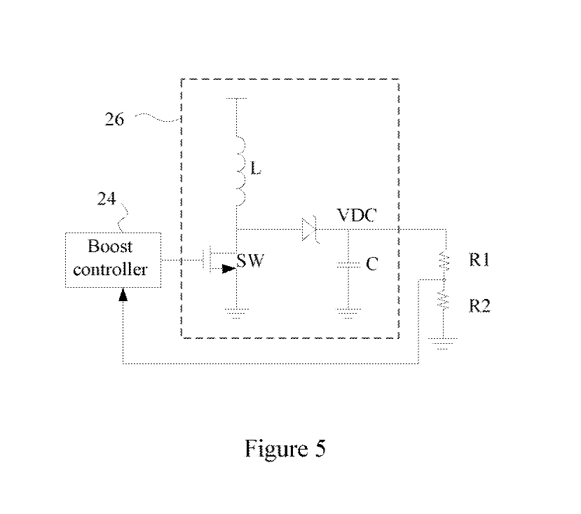

In another embodiment, the feedback regulating circuit further comprises a boost controller 24 and a boost power stage circuit 26, as shown in FIG. 5, showing a schematic diagram of detail circuits of the boost controller 24 and the boost power stage circuit 26. The boost controller 24 compares the reference voltage with a voltage at a voltage-divided node of the adjustable voltage source V_{DC} of the multi-output circuit, and accordingly outputs a feedback control signal to the boost power stage circuit 26. According to the feedback control signal, the boost power stage circuit 26 controls the voltage at the voltage-divided node of the voltage source V_{DC} to approximate the reference voltage so as to adjust the voltage of the adjustable voltage source V_{DC}. The desired voltage (e.g. the reference voltage) at voltage divided node is decided by using appropriate resistors R1 and R2. In this embodiment, for example, the boost power stage circuit 26 comprises a switching power supply, which comprises an N-type metal-oxide-semiconductor (NMOS) switch transistor (SW), and an energy storing circuit formed by an inductor L and/or a capacitor C, as shown in FIG. 5. The NMOS SW under the control of the voltage control signal performs voltage source switching.

In addition to feedback voltage regulation, the embodiments of the present invention also achieves error detection of the LEDs. For example, when a short circuit (or similar fault) occurs in one or more of the LEDs 100 of a given LED string 10, an abnormal rise of output voltages at a corresponding input pad 11 can be detected by the logic unit 220 by monitoring the voltage at the input pad 11 corresponding to the LED strings 10. In another embodiment, when an open circuit occurs in one or more LEDs 100 of a certain LED string 10, an abnormal decrease of output voltage at a corresponding input pad 11 is detected by the logic unit 220 by monitoring the voltage at the input pad 11. The result of detected errors is provided to other blocks of the system for further processing.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A feedback regulating circuit, for providing a regulated voltage to a multi-output circuit that outputs a plurality of output voltages, the feedback regulating circuit comprising:
a voltage control unit, coupled to the output voltages, for generating a first voltage according to the output voltages and outputting a voltage control signal according to the first voltage; and
a reference voltage generator, coupled to the voltage control unit, for receiving the voltage control signal to generate a reference voltage accordingly, with the reference voltage being fed back to the multi-output circuit.

2. The feedback regulating circuit as claimed in claim 1, further comprising:
an analog-to-digital converter (ADC), coupled to the multi-output circuit, for converting the plurality of output voltages to a plurality of digital voltages, wherein the voltage control unit selects one of the digital voltages as the first voltage.

3. The feedback regulating circuit as claimed in claim 1, wherein the voltage control unit comprises:
a logic unit, for selecting one of the digital voltages as the first voltage according to a predetermined rule, and generating the voltage control signal according to the first voltage.

4. The feedback regulating circuit as claimed in claim 3, wherein the reference voltage generator comprises a signal generator for generating a corresponding output signal according to the voltage control signal, and the signal generator is a pulse width modulation (PWM) signal generator that adjusts a pulse width of the output signal according to the voltage control signal.

5. The feedback regulating circuit as claimed in claim 4, wherein the logic unit compares the first voltage with a target voltage to generate the voltage control signal.

6. The feedback regulating circuit as claimed in claim 5, wherein the logic unit generates the voltage control signal according to a difference between the first voltage and the target voltage.

7. The feedback regulating circuit as claimed in claim 6, wherein the logic unit selects the minimum voltage of the plurality of digital voltages as the first voltage.

8. The feedback regulating circuit as claimed in claim 6, wherein the logic unit generates the voltage control signal in proportion to a ratio of the difference of the first voltage and the target voltage and the target voltage.

9. The feedback regulating circuit as claimed in claim 4, wherein the reference voltage generator further comprises:
a low-pass filter (LPF), for retrieving a direct current voltage component of the output signal as the reference voltage.

10. The feedback regulating circuit as claimed in claim 3, wherein the logic unit detects a status of the multi-output circuit according to the output voltages.

11. The feedback regulating circuit as claimed in claim 2, wherein the ADC comprises:
a multiplexer, for receiving the plurality of output voltages, and selecting one of the output voltages at a time to feed back to the ADC;
wherein the ADC unit converts the selected output voltage to a digital voltage.

12. The feedback regulating circuit as claimed in claim 1, further comprising:
a boost controller, for comparing the reference voltage with a divided voltage of an adjustable voltage source of the multi-output circuit, and generating a feedback control signal accordingly; and
a boost power stage circuit, for receiving the feedback control signal so that the divided voltage approximates the reference voltage to provide the adjustable voltage source.

13. The feedback regulating circuit as claimed in claim 12, wherein the boost power stage circuit comprises:
a switching power supply, controlled by the voltage control signal; and
an energy storing circuit.

14. The feedback regulating circuit as claimed in claim 13, wherein the switching power supply further comprises a N-type metal-oxide-semiconductor (NMOS) switch transistor (SW) under control of the voltage control signal, for performing voltage source switching.

15. The feedback regulating circuit as claimed in claim 13, wherein the energy storing circuit comprises an inductor.

16. The feedback regulating circuit as claimed in claim 13, wherein the energy storing circuit comprises a capacitor.

17. The feedback regulating circuit as claimed in claim 13, wherein the energy storing circuit comprises an inductor and a capacitor.

18. The feedback regulating circuit as claimed in claim 3, wherein the logic unit monitors the plurality of output voltages and detects errors in a corresponding section of the circuit when an abnormal increase or decrease of a given output voltage is detected.

19. The feedback regulating circuit as claimed in claim 18, wherein errors detected by the logic unit are accessible to other components for further processing.
